(19) United States
(12) Patent Application Publication
(10) Pub. No.: US 2013/0186973 A1
(43) Pub. Date: Jul. 25, 2013

(54) REMOTELY CONTROLLED FERTILIZER SPRAYER, AND METHOD FOR CONTROLLING SAME

(71) Applicant: Wan Soo Kim, Jeollabuk-Do (KR)

(72) Inventor: Wan Soo Kim, Jeollabuk-Do (KR)

(21) Appl. No.: 13/825,126

(22) PCT Filed: Apr. 26, 2011
(86) PCT No.: PCT/KR2011/003035

§ 371 Date: Mar. 20, 2013

(30) Foreign Application Priority Data
Apr. 26, 2011 (KR) PCT/KR2011/003035
Sep. 20, 2012 (KR) 10-2010-0092545

(51) Int. Cl. A01C 23/00

(52) U.S. Cl. CPC A01C 23/007
USPC 239/11; 239/74

(57) ABSTRACT

The present invention relates to a remotely controlled fertilizer sprayer and to a method for controlling the sprayer, and more particularly, to a remotely controlled fertilizer sprayer and to a method for controlling the sprayer which involve using a wireless remote controller to precisely adjust and control a sprayed amount and a spraying speed of the sprayer, thereby optimally spraying fertilizer or seeds. To this end, provided are a remotely controlled fertilizer sprayer and a method for controlling the sprayer, wherein the sprayer includes: a main receiving controller fixed on a frame of a fertilizer sprayer installed on a carrier such as a vehicle or tractor; and a wireless transmitting remote controller operated by a driver or a third party. Thus, the sprayed amount and spraying speed of the sprayer are remotely and precisely adjusted and controlled, thereby enabling the optimal and precise spraying of fertilizer or seeds in a certain area.

### CROSS-REFERENCE TO RELATED APPLICATION

This application claims the benefit of Korean Patent Application No. 10-2010-0092545, filed on Sep. 20, 2010 in the Korean Intellectual Property Office, the disclosure of which is incorporated herein by reference.

### TECHNICAL FIELD

The present invention relates to a remotely controlled fertilizer sprayer and a method of controlling the same, and more particularly, to a remotely controlled fertilizer sprayer and a method of controlling the same that can spray a fertilizer or seeds in an optimal state by precisely adjusting a spray amount and a spray speed of a fertilizer of the fertilizer sprayer at a remote distance using a wireless remote controller.

### BACKGROUND ART

A fertilizer sprayer that may be used by mounting in various traveling means such as a tractor or a cultivator is produced in various structures using an ejection method using an air compressive force, a spray method using a centrifugal force by rotation of an impeller, or a drop method by rotation of a shaft in which a fertilizer exhaust blade is formed.

Such a fertilizer sprayer should be easily detached from a farm machine such as a tractor and should be produced in a structure in which a worker alone can easily detach in a farm village of a shortage of hands, particularly, in a structure that may be automatically sprayed using an electric motion means.

In consideration of this, the present applicant applied Korean Patent Application No. 2010-0074947 titled “fertilizer sprayer of automatic and manual combined use” that can uniformly maintain an exhaust amount of a fertilizer by automatically controlling a motion of a shutter that switches an exhaust amount of the fertilizer using an electric motion cylinder and that can easily spray the fertilizer moved downward to a fertilizer spray rotation plate to a super wide area by a centrifugal force of the fertilizer spray rotation plate rotating by motor driving according to a shutter manipulation of the electric motion cylinder.

However, the patent application titled “fertilizer sprayer of automatic and manual combined use” can somewhat adjust an exhaust amount of a fertilizer by controlling a motion (opening and closing angle) of a shutter that opens and closes an exhaust port of the fertilizer sprayer using an electric motion cylinder or a manual operation device installed at a driver seat, but there was a defect that adjusts only an exhaust amount and cannot know whether a fertilizer or seeds are adjusted and exhausted in which amount, and unnecessary spray is performed due to such a defect, and thus a fertilizer or seeds are wasted, and spray is not precisely performed in an optimal state.

Particularly, when spraying seeds of a high price, accurate spray is requested, but a spray amount of the seeds cannot be adjusted to a desired level, and accurate spray is not performed and a large quantity of spray is thus uselessly performed and thus seeds may be wasted.

### DISCLOSURE

### Technical Problem

The present invention is made to overcome the above mentioned problems, and it is an object of the present invention to provide a remotely controlled fertilizer sprayer and a method of controlling the same that can spray a fertilizer or seeds in an optimal state in a predetermined area by precisely adjusting a spray amount and a spray speed of the fertilizer of a fertilizer sprayer installed in a traveling means.

### Technical Solution

To achieve the above objects, there is provided a remotely controlled fertilizer sprayer including a shutter for adjusting opening and closing of a fertilizer guide hole of a fertilizer exhaust valve positioned at the lower end of a hopper of the fertilizer sprayer, an electric motion cylinder for adjusting an opening and closing angle of a fertilizer guide hole by angular-rotating the shutter, a fertilizer spray rotation plate positioned at a lower portion of the fertilizer exhaust valve to spray a fertilizer while rotating, and a motor for rotating the fertilizer spray rotation plate, the remotely controlled fertilizer sprayer including: a receiving main controller connected to the electric motion cylinder and the motor by a wire to adjust a spray amount and a spray speed of the fertilizer, wherein the receiving main controller is fixed to a front side frame of the fertilizer sprayer and is connected to a battery of a traveling means, and at the outside thereof, a signal receiving antenna is installed, or at the inside thereof, a signal receiving antenna and a main control board are housed; a wireless transmitting remote controller connected to the receiving main controller by wireless to adjust a spray amount and a spray speed of the fertilizer by manipulation of a driver or a third party, wherein at the outside of the wireless transmitting remote controller, a signal transmitting antenna is installed, and at the inside thereof, a rechargeable battery and a transmitting control board are housed, and at the outside thereof, and a switch for turning on/off the electric motion cylinder and the motor connected to transmit and from a signal to and from the transmitting control board, a first up/down switch for increasing or decreasing a spray amount by adjusting an opening and closing angle of the shutter by the electric motion cylinder, a second up/down switch for increasing or decreasing a spray speed of the fertilizer spray rotation plate by the motor, and a liquid crystal screen for displaying the spray amount and the spray speed with a numerical value are formed.

Preferably, at the outside of the receiving main controller, the switch for turning on/off the electric motion cylinder and the motor connected to transmit and receive a signal to and from the main control board, the first up/down switch for increasing or decreasing a spray amount by adjusting an opening and closing angle of the shutter by the electric motion cylinder, the second up/down switch for increasing or decreasing a spray speed of the fertilizer spray rotation plate by the motor, and the liquid crystal screen for displaying the spray amount and the spray speed with a numerical value are formed.

To achieve the above objects, there is provided a method of controlling a remotely controlled fertilizer sprayer, the method including: turning on a switch of a wireless transmitting remote controller carried by a driver or a third party; determining an opening and closing angle of the shutter by the electric motion cylinder by performing up or down manipulation of a first up/down switch of the remote controller and determining a spray speed of the fertilizer spray rotation plate by the motor by performing up or down manipulation of a second up/down switch of the remote controller; transmitting a signal of the spray amount and the spray speed determined by the first up/down switch and the second up/down switch of the wireless transmitting remote controller to the receiving main controller through a transmitting control board and a signal transmitting antenna; receiving a spray amount and spray speed signal determined in a signal receiving antenna of the receiving main controller, and transferring, when transmitting the spray amount and spray speed signal to a main control board, by the main control board of the receiving main controller, a driving instruction to the electric motion cylinder to correspond to the determined spray amount and simultaneously transferring a driving instruction to the motor to correspond to the determined spray speed; and adjusting a spray speed of the fertilizer spray rotation plate by driving the motor to correspond to the determined spray speed while adjusting an opening and closing angle of the shutter by driving a piston of the electric motion cylinder to correspond to the determined spray amount.

Preferably, the method further includes displaying the determined spray amount and spray speed on the liquid crystal screens of the wireless transmitting remote controller and the receiving main controller.

Particularly, the method further includes: driving, when the wireless transmitting remote controller is failed, the electric motion cylinder and the motor by turning on the switch of the receiving main controller; adjusting an opening and closing angle by the shutter by the electric motion cylinder by performing up or down manipulation of the first up/down switch of the receiving main controller; and adjusting a spray speed of the fertilizer spray rotation plate by the motor by performing up or down manipulation of the second up/down switch of the receiving main controller.

Further, the method further includes controlling, when the switch of the receiving main controller is tuned off, to move a position of an opening and closing angle of the shutter by the electric motion cylinder to a position that completely blocks the fertilizer guide hole.

Further, the method further includes: sensing, by a main control board of the receiving main controller, a current value according to a load amount of the motor, and controlling, if the current value is a low load less than a reference value, to generate a warning sound notifying that a fertilizer for spray is entirely consumed or to display “empty” on the liquid crystal screens of the transmitting remote controller and the receiving main controller.

Further, the method further includes sensing, by the main control board of the receiving main controller, a current value according to a load amount of the motor, and controlling, if the current value is an overload equal to or larger than a reference value, to inversely rotate the motor in order to solve the overload.

Preferably, a shutter open angle by the electric motion cylinder increases or decreases in a unit of 1% in a range of minimum 1% to maximum 100% by one time up or down manipulation of the first up/down switches of the receiving main controller and the transmitting remote controller.

Further, a speed of the motor increases or decreases in a unit of 20 rpm in a range of minimum 200 rpm to maximum 3000 rpm by one time up or down manipulation of the second up/down switches of the receiving main controller and the transmitting remote controller.

### Advantageous Effects

The present invention provides the following effects through the object solving means.

A receiving main controller is installed in a fertilizer sprayer installed in a traveling means such as a tractor according to the present invention, and as a driver or a third party carries and manipulates a wireless transmitting remote controller for performing wireless communication with the receiving main controller, a spray amount and a spray speed of a fertilizer of the fertilizer sprayer can be more precisely adjusted at a remote distance.

Particularly, by precisely adjusting and spraying a spray amount or a spray speed of a fertilizer or seeds in an optimal state in a predetermined area, a fertilizer or seeds of a high price can be prevented from being uselessly wasted.

Further, because a driver can concentrate on driving a traveling means such as a tractor and a peripheral third party can spray a fertilizer or seeds by manipulating a remote controller, upon spraying the fertilizer or the seeds, safety can be improved.

Further, because a spray amount and a spray speed can be determined while viewing a liquid crystal screen of a wireless transmitting remote controller, precise spray can be performed in an optimal state.

### BRIEF DESCRIPTION OF DRAWINGS

FIG. 1 is a perspective view illustrating a configuration of a remotely controlled fertilizer sprayer according to an exemplary embodiment of the present invention.

FIG. 2 is a perspective view illustrating a connection relationship of a remotely controlled fertilizer sprayer according to an exemplary embodiment of the present invention.

FIG. 3 is a schematic diagram illustrating a state in which a remotely controlled fertilizer sprayer is installed and used in a tractor according to an exemplary embodiment of the present invention.

FIGS. 4 and 5 are perspective views illustrating a configuration of a fertilizer sprayer.

### DESCRIPTION OF SYMBOLS

10: receiving main controller 11: first up/down switch
12: second up/down switch 13: switch
14: liquid crystal screen 15: signal receiving antenna
20: wireless transmitting remote controller 21: first up/down switch
22: second up/down switch 23: switch
24: liquid crystal screen 25: signal transmitting antenna
100: main frame 102: first horizontal frame
104: second horizontal frame 106: fertilizer spray rotation plate
108: motor 110: fertilizer guide hole
112: fertilizer exhaust valve 114: shutter
116: electric motion cylinder 118: fertilizer sprayer hopper

### BEST MODES FOR CARRYING OUT THE INVENTION

Hereinafter, an exemplary embodiment of the present invention will be described in detail with reference to the accompanying drawings.

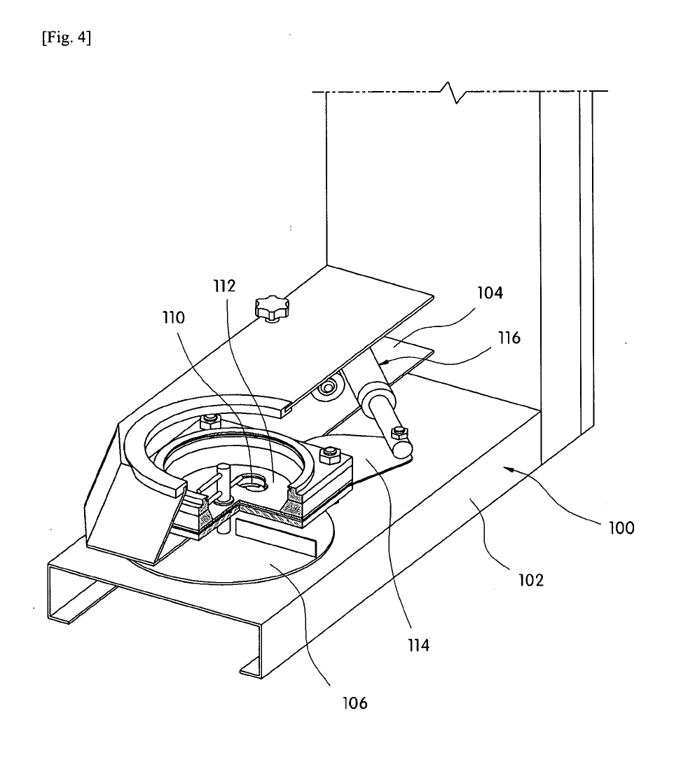

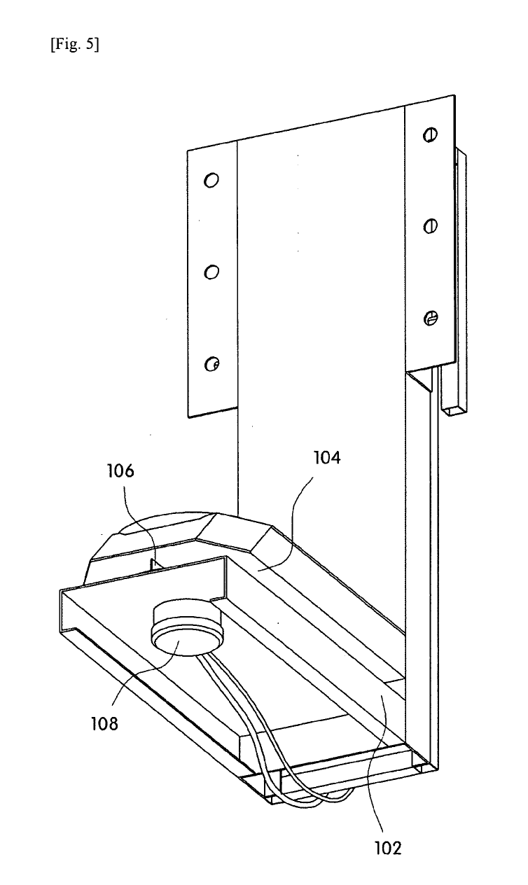

First, for a better understanding of the present invention, a configuration and an operation state of a fertilizer sprayer will be described with reference to FIGS. 4 and 5.

At the bottom of a first horizontal frame 102 of a main frame 100 forming a frame of the fertilizer sprayer, a motor 108, which is a driving source for spraying a fertilizer by a centrifugal force is mounted, and at an upper surface of the first horizontal frame 102, a fertilizer spray rotation plate 106 is rotatably mounted.

Further, at an upper surface of a second horizontal frame 104 of the main frame 100, a fertilizer exhaust valve 112 having a fertilizer guide hole 110 is disposed to close contact, and a shutter 114 for adjusting opening and closing of the fertilizer guide hole 110 is angular-rotatably mounted between the second horizontal frame 104 and the fertilizer exhaust valve 112.

That is, the internal side end of the shutter 114 becomes a portion that opens and closes the fertilizer guide hole 110 of the fertilizer exhaust valve 112, and the external side end of the shutter 114 is not inserted between the second horizontal frame 104 and the fertilizer exhaust valve 112 and becomes a portion connected to a electric motion cylinder 116 mounted in the second horizontal frame 104.

Therefore, when a fertilizer is filled within a hopper 118 of the fertilizer sprayer, as a piston moves in the front-rear direction by driving of the electric motion cylinder 116, the shutter 114 performs an angular rotation and thus an opening and closing angle of the shutter 114 that opens and closes the fertilizer guide hole 110 of the fertilizer exhaust valve 112 is adjusted, and a fertilizer or seeds moved downward through the fertilizer guide hole 110 is simultaneously moved downward to the fertilizer spray rotation plate 106.

Thereafter, as the fertilizer spray rotation plate 106 rotates by a rotation driving force of the motor 108, the fertilizer or the seeds moved downward to the fertilizer spray rotation plate 106 are easily sprayed to a super wide area by a centrifugal force of the fertilizer spray rotation plate 106.

The present invention is characterized by adjusting a spray amount and a spray speed of a fertilizer or seeds to be sprayed to an optimal state by precisely controlling driving of a motor and an electric motion cylinder of the fertilizer sprayer having the above configuration and operation state.

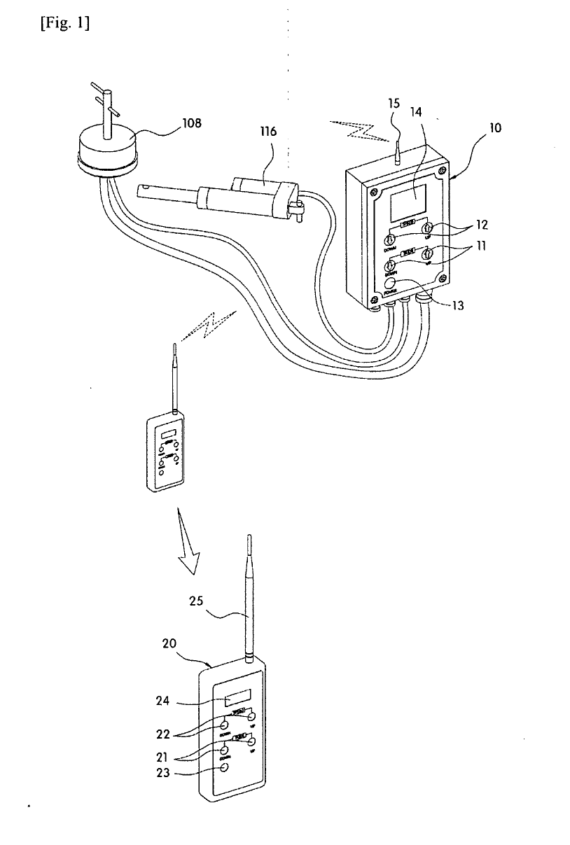

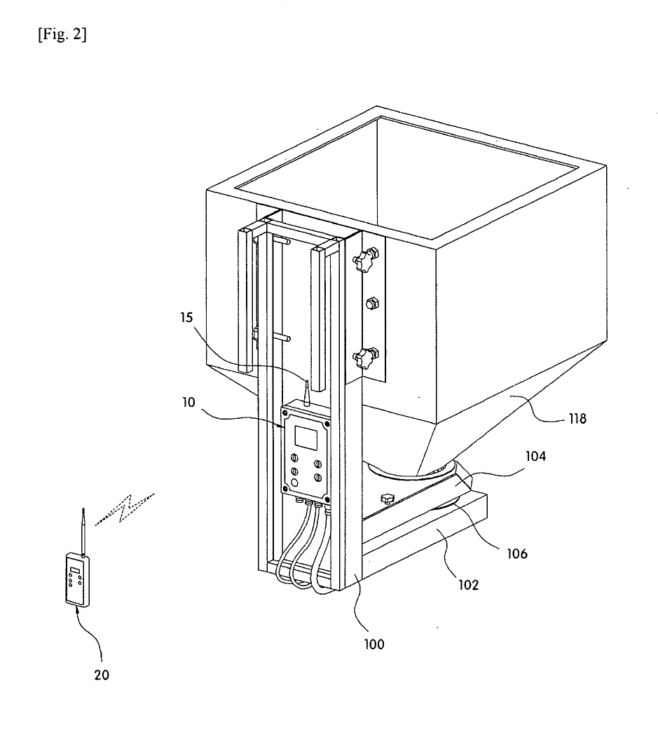

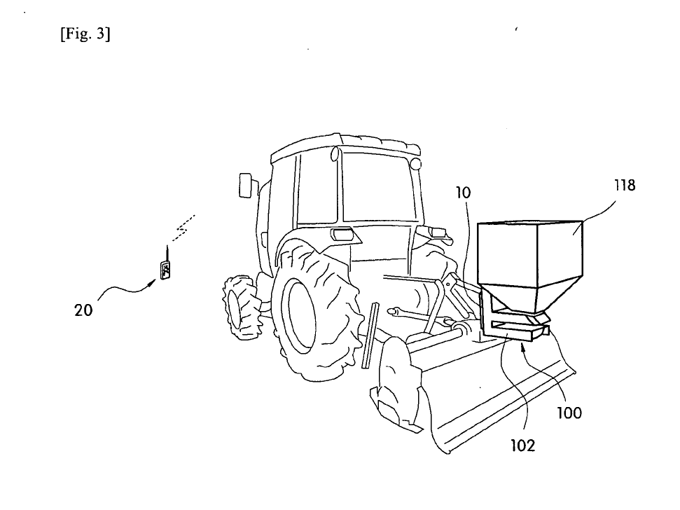

For this purpose, as shown in FIGS. 1 and 2, the present invention is characterized in that at a front side frame of the fertilizer sprayer, a receiving main controller 10 connected to the electric motion cylinder 116 and the motor 108 by a wire to adjust a spray amount and a spray speed of a fertilizer is mounted, and a wireless transmitting remote controller 20 carried by a driver or a third party and that can adjust a spray amount and a spray speed of the fertilizer is connected by wireless to the receiving main controller 10, and FIG. 3 illustrates a state in which a remotely controlled fertilizer sprayer of the present invention is installed and used in a traveling means such as a tractor.

The receiving main controller 10 is fixed to a front side frame of the fertilizer sprayer and is connected to a battery of a traveling means (e.g., a vehicle or a tractor), and at the outside thereof, a signal receiving antenna 15 is installed, or at the inside thereof, a signal receiving antenna and a main control board are housed.

It is preferable that the receiving main controller 10 and the wireless transmitting remote controller 20 are covered with a waterproof case, and by covering a waterproof case at the receiving main controller 10 and the wireless transmitting remote controller 20, a fertilizer or seeds can be sprayed while preventing penetration of rainfall at a rainy day.

Further, at the outside of a box of the receiving main controller 10, an on/off switch 13 for turning on/off the electric motion cylinder 116 and the motor 108 is formed at the lower end, and a first up/down switch 11 for increasing or decreasing a spray amount by adjusting an opening and closing angle of the shutter 114 by the electric motion cylinder 116 and a second up/down switch 12 for increasing or decreasing a spray speed of the fertilizer spray rotation plate 106 by the motor 108 are formed in an intermediate portion, and a liquid crystal screen 14 for displaying the spray amount and the spray speed with a numerical value is formed in an upper end portion.

In this case, the on/off switch 13 of the receiving main controller 10, the first and second up/down switches 11 and 12, and the liquid crystal screen 14 are connected to transmit and receive a signal to and from a main control board installed at the inside.

The wireless transmitting remote controller 20 may be carried and used by a driver seated at a driver seat, may be installed and used at a predetermined position of a driver seat, or may be carried and used by a third party at a periphery of a fertilizer spray area, and at the inside of the box of the transmitting remote controller 20, a rechargeable battery (not shown) and a transmitting control board (not shown) are housed, and as shown in FIG. 1, at the outside of the box, a signal transmitting antenna 25 is installed.

Further, at the outside of the box of the wireless transmitting remote controller 20, an on/off switch 23 for turning on/off the electric motion cylinder 116 and the motor 108 is formed at the lower end, a first up/down switch 21 for increasing or decreasing a spray amount by adjusting an opening and closing angle of the shutter 114 by the electric motion cylinder 116 and the second up/down switch 22 for increasing or decreasing a spray speed of the fertilizer spray rotation plate 106 by the motor 108 are formed in an intermediate portion, and a liquid crystal screen 24 for displaying a spray amount and a spray speed with a numerical value is formed in an upper end portion.

Further, an on/off switch 23, the first and second up/down switches 21 and 22, and the liquid crystal screen 24 of the transmitting remote controller 20 are connected to transmit and receive an electrical signal to and from an internal transmitting control board.

Further, in the present invention, by connecting the transmitting remote controller 20 to the receiving main controller 10 using a wire, at a driver seat of a traveling means (e.g., a vehicle or a tractor) in which the fertilizer sprayer is installed, a driver may manipulate the fertilizer sprayer.

Hereinafter, a method of controlling a fertilizer sprayer according to an exemplary embodiment of the present invention having the above configuration will be described with reference to FIG. 1 to FIG. 3.

First, by turning on the switch 13 of the receiving main controller 10, the motor 108 and the electric motion cylinder 116 of the fertilizer sprayer are turned on and by simultaneously turning on the switch 23 of the wireless transmitting remote controller 20 carried by a driver or a third party, the wireless transmitting remote controller 20 is in a state that can perform wireless communication with the receiving main controller 10.

Next, by manipulating the wireless transmitting remote controller 20, the driver adjusts a spray amount and a spray speed of the fertilizer, and it is preferable that the driver concentrates on driving a traveling means such as a tractor and a peripheral third party adjusts a spray amount and a spray speed of the fertilizer by manipulating the wireless transmitting remote controller 20.

That is, by performing up or down manipulation of the first up/down switch 21 of the wireless transmitting remote controller 20, the driver or the third party determines an opening and closing angle of the shutter 114 by the electric motion cylinder 116 or by performing up or down manipulation of the second up/down switch 22 of the remote controller 20, the driver or the third party determines a spray speed of the fertilizer spray rotation plate 106 by the motor 108.

In more detail, by performing one time up or down manipulation of the first up/down switch 21 of the wireless transmitting remote controller 20, an open angle of the shutter 114 by the electric motion cylinder 116 is increased or decreased in a unit of 1% in a range of minimum 1% to maximum 100%, and by performing an up or down manipulation of the first up/down switch 21 by the desired number of times, an open angle, i.e., a fertilizer spray amount of the shutter 114 by the electric motion cylinder 116 is determined to a desired level.

Further, by performing one time up or down manipulation of the second up/down switch 22 of the wireless transmitting remote controller 20, a speed of the motor 108 is increased or decreased in a unit of 20 rpm in a range of minimum 200 rpm to maximum 3000 rpm, and similarly, by performing an up or down manipulation of the second up/down switch 22 by the desired number of times, a rotation speed, i.e., a fertilizer spray speed of the fertilizer spray rotation plate 106 by the motor 108 is determined to a desired level.

Next, a signal of the spray amount and the spray speed of the fertilizer determined by the driver or the third party is transmitted to the receiving main controller 10 through the signal transmitting antenna 25 and a transmitting control board of the transmitting remote controller 20.

Thereafter, when a signal receiving antenna of the receiving main controller 10 receives a signal of the spray amount and the spray speed determined in the transmitting remote controller 20 and sends the spray amount and spray speed signal to the main control board, the main control board of the receiving main controller 10 transfers a driving instruction to the electric motion cylinder 116 to correspond to the determined spray amount and simultaneously transfers a driving instruction to the motor 108 to correspond to the determined spray speed.

Therefore, by driving a piston of the electric motion cylinder 116 to correspond to the determined spray amount according to an instruction from the main control board of the receiving main controller 10, an opening and closing angle of the shutter 114 is adjusted to a desired level, and by driving the motor 108 to correspond to the determined spray speed, a spray speed of the fertilizer spray rotation plate 106 is adjusted to a desired level.

In other words, by driving a piston of the electric motion cylinder 116 to correspond to the determined spray amount by manipulating the transmitting remote controller 20, an opening and closing angle of the shutter 114 connected to the piston, i.e., an opening and closing angle of the shutter 114 that opens and closes the fertilizer guide hole 110 is adjusted to a desired level and thus a fertilizer or seeds filled within the hopper 118 of the fertilizer sprayer moves downward to the fertilizer spray rotation plate 106 by a desired spray amount through the fertilizer guide hole 110.

Further, while a rotation speed of the motor 108 is adjusted to correspond to the spray speed determined by manipulating the transmitting remote controller 20, the fertilizer spray rotation plate 106 rotates with a desired speed and thus the fertilizer or the seeds moved downward to the fertilizer spray rotation plate 106 is sprayed with a desired spray width (range of radius 2-25 m) by a centrifugal force of the fertilizer spray rotation plate 106.

In this case, on the liquid crystal screens 14 and 24 of the wireless transmitting remote controller 20 and the receiving main controller 10, a spray amount and a spray speed of the fertilizer or the seeds are displayed and thus the driver and the third party can always visually determine a present state of a spray amount and a spray speed.

The main control board of the receiving main controller 10 senses in real time a current value according to a load amount of the motor 108, and when the current value is a low load less than a reference current value, it is determined that the entire fertilizer filled within the hopper is consumed, a control step of generating a warning sound notifying this or displaying “empty” on the liquid crystal screens 14 and 24 of the transmitting remote controller 20 and the receiving main controller 10 is performed, and thus the driver or the third party that recognizes this refills a fertilizer or seeds into the hopper.

However, the main control board of the receiving main controller 10 senses a current value according to a load amount of the motor 108, and when the current value is an overload equal to or larger than a reference value (when a large amount of fertilizer is instantaneously concentrated to the fertilizer spray rotation plate), in order to solve the overload, by performing a control step of inversely rotating the motor 108, an overload state can be easily solved.

After a spray work is performed while precisely adjusting a spray amount and a spray speed of a fertilizer or seeds, in order to terminate the spray work, when the switches 13 and 23 of the receiving main controller 10 and the transmitting remote controller 20 are turned off, a position of an opening and closing angle of the shutter 114 by the electric motion cylinder 116 is moved to a position that completely blocks the fertilizer guide hole 110 and thus the fertilizer or the seeds are no longer exhausted through the fertilizer guide hole 110.

When the wireless transmitting remote controller 10 carried by the driver or the third party is failed, by manipulating the receiving main controller 10 mounted in the fertilizer sprayer with the following method, the foregoing fertilizer spray process can be equally performed.

First, when the wireless transmitting remote controller 20 carried by the driver or the third party is failed, by turning on the switch 13 of the receiving main controller 10, the electric motion cylinder 116 and the motor 108 are driven.

Thereafter, by performing up or down manipulation of the first up/down switch 11 of the receiving main controller 10, an opening and closing angle of the shutter 114 by the electric motion cylinder 116 is adjusted to a desired level, and by simultaneously performing up or down manipulation of the second up/down switch 12 of the receiving main controller 10, a spray speed of the fertilizer spray rotation plate 106 by the motor 108 is adjusted to a desired level.

Therefore, by manipulating the first up/down switch 11 of the receiving main controller 10, as an opening and closing angle of the shutter 114 that opens and closes the fertilizer guide hole 110 is adjusted to a desired level, the fertilizer or the seeds filled within the hopper 118 of the fertilizer sprayer move downward by a desired spray amount to the fertilizer spray rotation plate 106 through the fertilizer guide hole 110.

Further, by manipulating the second up/down switch 12 of the receiving main controller 10, as a rotation speed of the motor 108 is adjusted to a desired level, the fertilizer or the seeds moved downward to the fertilizer spray rotation plate 106 are sprayed to a desired spray width (range of radius 2-25 m) by a centrifugal force of the fertilizer spray rotation plate 106.

1. A remotely controlled fertilizer sprayer comprising a shutter 114 for adjusting opening and closing of a fertilizer guide hole 110 of a fertilizer exhaust valve 112 positioned at the lower end of a hopper 118 of the fertilizer sprayer, an electric motion cylinder 116 for adjusting an opening and closing angle of the fertilizer guide hole 110 by angular-rotating the shutter 114, a fertilizer spray rotation plate 106 positioned at a lower portion of the fertilizer exhaust valve 112 to spray a fertilizer while rotating, and a motor 108 for rotating the fertilizer spray rotation plate 106, the remotely controlled fertilizer sprayer comprising:
a receiving main controller 10 connected to the electric motion cylinder 116 and the motor 108 by a wire to adjust a spray amount and a spray speed of the fertilizer, wherein the receiving main controller 10 is fixed to a front side frame of the fertilizer sprayer and is connected to a battery of a traveling means, and at the outside thereof, a signal receiving antenna 15 is installed, or at the inside thereof, a signal receiving antenna and a main control board are housed;
a wireless transmitting remote controller 20 connected to the receiving main controller 10 by wireless to adjust a spray amount and a spray speed of the fertilizer by manipulation of a driver or a third party,
wherein at the outside of the wireless transmitting remote controller 20, a signal transmitting antenna 25 is installed, and at the inside thereof, a rechargeable battery and a transmitting control board are housed, and at the outside thereof, and a switch 23 for turning on/off the electric motion cylinder 116 and the motor 108 connected to transmit and from a signal to and from the transmitting control board, a first up/down switch 21 for increasing or decreasing a spray amount by adjusting an opening and closing angle of the shutter 114 by the electric motion cylinder 116, a second up/down switch 22 for increasing or decreasing a spray speed of the fertilizer spray rotation plate 106 by the motor 108, and a liquid crystal screen 24 for displaying the spray amount and the spray speed with a numerical value are formed.

2. The remotely controlled fertilizer sprayer of claim 1, wherein at the outside of the receiving main controller 10, a switch 13 for turning on/off the motor 108 and the electric motion cylinder 116 connected to transmit and receive a signal to and from a main control board, a first up/down switch 11 for increasing or decreasing a spray amount by adjusting an opening and closing angle of the shutter 114 by the electric motion cylinder 116, a second up/down switch 12 for increasing or decreasing a spray speed of the fertilizer spray rotation plate 106 by the motor 108, and a liquid crystal screen 14 for displaying the spray amount and the spray speed with a numerical value are formed.

3. The remotely controlled fertilizer sprayer of claim 1, wherein the receiving main controller 10 and the wireless transmitting remote controller 20 are connected by a wire in order for a driver to manipulate the fertilizer sprayer at a driver seat of a traveling means.

4. The remotely controlled fertilizer sprayer of claim 1, wherein the receiving main controller 10 and the wireless transmitting remote controller 20 are covered with a waterproof case.

5. A method of controlling a remotely controlled fertilizer sprayer, the method comprising:
turning on, by a driver or a third party, a switch 23 of a wireless transmitting remote controller 20;
determining an opening and closing angle of a shutter 114 by an electric motion cylinder 116 by performing up or down manipulation of a first up/down switch 21 of the remote controller 20 and determining a spray speed of a fertilizer spray rotation plate 106 by a motor 108 by performing up or down manipulation of a second up/down switch 22 of the remote controller 20;
transmitting a signal of the spray amount and the spray speed determined by the first up/down switch 21 and the second up/down switch 22 of the wireless transmitting remote controller 20 to a receiving main controller 10 through a transmitting control board and the signal transmitting antenna 25;
receiving the spray amount and spray speed signal determined in a signal receiving antenna of the receiving main controller 10, and transferring, when transmitting the spray amount and spray speed signal to a main control board, by the main control board of the receiving main controller 10, a driving instruction to the electric motion cylinder 116 to correspond to the determined spray amount and simultaneously transferring a driving instruction to the motor 108 to correspond to the determined spray speed; and
adjusting a spray speed of the fertilizer spray rotation plate 106 by driving the motor 108 to correspond to the determined spray speed while adjusting an opening and closing angle of the shutter 114 by driving a piston of the electric motion cylinder 116 to correspond to the determined spray amount.

6. The method of claim 5, further comprising displaying the determined spray amount and spray speed on liquid crystal screens 14 and 24 of the wireless transmitting remote controller 20 and the receiving main controller 10.

7. The method of claim 5, further comprising:
driving, when the wireless transmitting remote controller 10 is failed, the electric motion cylinder 116 and the motor 108 by turning on a switch 13 of the receiving main controller 10;
adjusting an opening and closing angle by the shutter 114 by the electric motion cylinder 116 by performing up or down manipulation of the first up/down switch 11 of the receiving main controller 10; and
adjusting a spray speed of the fertilizer spray rotation plate 106 by the motor 108 by performing up or down manipulation of the second up/down switch 12 of the receiving main controller 10.

8. The method of claim 5, further comprising controlling, when the switch 13 of the receiving main controller 10 is tuned off, to move a position of an opening and closing angle of the shutter 114 by the electric motion cylinder 116 to a position that completely blocks the fertilizer guide hole 110.

9. The method of claim 5, further comprising sensing, by a main control board of the receiving main controller 10, a current value according to a load amount of the motor 108, and controlling, if the current value is a low load less than a reference value, to generate a warning sound notifying that a fertilizer for spray is entirely consumed or to display “empty” on the liquid crystal screens 14 and 24 of the transmitting remote controller and the receiving main controller.

10. The method of claim 5, further comprising sensing, by the main control board of the receiving main controller 10, a current value according to a load amount of the motor 108, and inversely rotating, if the current value is an overload equal to or larger than a reference value, the motor 108 in order to solve the overload.

11. The method of claim 5, wherein a shutter open angle by the electric motion cylinder 116 increases or decreases in a unit of 1% in a range of minimum 1% to maximum 100% by one time up or down manipulation of the first up/down switches 11 and 21 of the receiving main controller 10 and the transmitting remote controller 20.

12. The method of claim 5, wherein a speed of the motor 108 increases or decreases in a unit of 20 rpm in a range of minimum 200 rpm to maximum 3000 rpm by one time up or down manipulation of the second up/down switches 12 and 22 of the receiving main controller 10 and the transmitting remote controller 20.
